(19) United States
(12) Patent Application Publication
(10) Pub. No.: US 2019/0229402 A1
(43) Pub. Date: Jul. 25, 2019

(54) Antenna component and mobile terminal

(71) Applicant: AAC Technologies Pte. Ltd., Singapore City (SG)

(72) Inventors: Xiaoyue Xia, Shenzhen (CN); Chao Wang, Shenzhen (CN)

(21) Appl. No.: 16/234,797

(22) Filed: Dec. 28, 2018

(30) Foreign Application Priority Data
Jan. 25, 2018 (CN) 201810070550.9

(51) Int. Cl. H01Q 1/24; H01Q 1/38; H01Q 21/28

(52) U.S. Cl. CPC H01Q 1/243; H01Q 21/28; H01Q 1/38

(57) ABSTRACT

The present disclosure provides an antenna component. The antenna component is applied in a mobile terminal including a 3D glass housing and a PCB received in the 3D glass housing. The antenna component includes a flexible circuit board having one end fixed to the PCB and another end bent and extending to be closely attached to an inner surface of the 3D glass housing. The flexible circuit board includes a first portion closely attached to an inner surface of the screen, a second portion arranged oppositely to the first portion and closely attached to an inner surface of the back cover and a third portion connected to the first portion and the second portion and closely attached to an inner surface of the side wall. The antenna component further includes first, second and third antenna arrays arranged on the first, second and third portions, respectively.

### CROSS-REFERENCE TO RELATED APPLICATIONS

The present application claims priority to Chinese Patent Application No. 201810070550.9, filed on Jan. 25, 2018, the content of which is incorporated herein by reference in its entirety.

### TECHNICAL FIELD

The present disclosure relates to the technical field of antennas, and in particular, to an antenna component and a mobile terminal.

### BACKGROUND

In a wireless communication device, there is always an apparatus for radiating electromagnetic energy to space and receiving electromagnetic energy from space. This apparatus is an antenna, which is used to transmit digital or analog signals modulated into radio frequencies to spatial wireless channels, or receive digital or analog signals modulated into radio frequencies from spatial wireless channels.

The 5^{th} Generation (5G) is the focus of global research and development in the industry. It has become a consensus in the industry to develop 5G technologies and 5G standards. Main application scenarios of 5G have been agreed in International Telecommunication Union (ITU)—RWP5D Meeting 22# in June, 2015. Three main application scenarios have been defined by the ITU: enhanced Mobile Broad Band, Massive Machine Type Communications and Ultra Reliable Low Latency Communications. These three application scenarios correspond to different key requirements. For example, the enhanced Mobile Broad Band scenario requires a peak user rate of 20 Gbps and a minimum user experience rate of 100 Mbps. In order to meet these strict requirements, several key technologies will be adopted, including the millimeter wave technology.

Rich bandwidth resources in millimeter wave bands guarantee high transmission rates. However, as the electromagnetic waves in these bands suffer from severe spatial losses, wireless communication systems operating in millimeter wave bands need to use phased array structures. With phase shifters, phases of respective array elements are distributed in some pattern to form high-gain beams. By changing the phases, the beams can swipe in a particular spatial range.

It is a mainstream in the future to use mobile terminal structures having three-dimensional (3D) glass. This is because the 3D glass has advantages such as light-weight, slimness, anti-fingerprint, resistance and excellent touch feel. Moreover, due the future technologies such as wireless charging and 5G millimeter wave antennas, metal housings with screening effects will be abandoned and the 3D glass having superior physical performances will become a preference.

There is thus a need for a novel antenna component to solve the above problem.

### BRIEF DESCRIPTION OF DRAWINGS

In order to explain the solutions according to the embodiments of the present disclosure more clearly, the figures used in the description of the embodiments will be introduced briefly below. Obviously, the following figures only illustrate some of the embodiments of the present disclosure. Other figures can be obtained by those having ordinary skill in the art from these figures without any inventive efforts. In the figures:

FIG. 1 is a schematic diagram showing a structure of a mobile terminal according to the present disclosure;

FIG. 2 is a schematic diagram showing a structure of an antenna component according to the present disclosure;

FIG. 3 is a schematic diagram showing an arrangement of an antenna component in a mobile terminal according to the present disclosure;

FIG. 4(a) are direction diagrams of the first antenna array in an antenna component according to the present disclosure;

FIG. 4(b) are direction diagrams of the third antenna array in an antenna component according to the present disclosure;

FIG. 4(c) are direction diagrams of the second antenna array in an antenna component according to the present disclosure; and

FIG. 5 is a schematic diagram showing a coverage efficiency of an antenna component according to the present disclosure.

### DESCRIPTION OF EMBODIMENTS

In the following, the solutions according to the embodiments of the present disclosure will be described clearly and fully with reference to the figures. Obviously, the embodiments described below are only some, rather than all, of the embodiments of the present disclosure. All other embodiments that can be obtained by those skilled in the art from the embodiments described below without any inventive efforts are to be encompassed by the scope of the present disclosure.

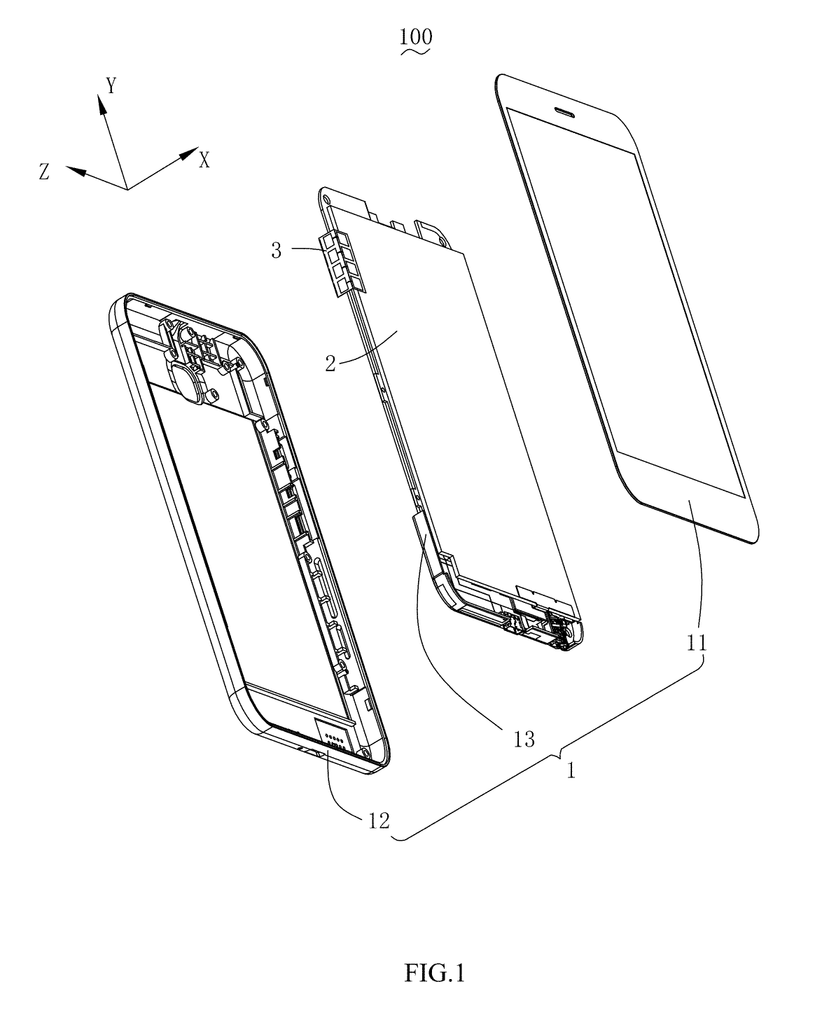

Referring to FIG. 1, a mobile terminal 100, e.g., a mobile phone, is provided according to an embodiment of the present disclosure. The mobile terminal 100 includes a three-dimensional (3D) glass housing 1 and a Printed Circuit Board (PCB) 2 received in the 3D glass housing and an antenna component 3.

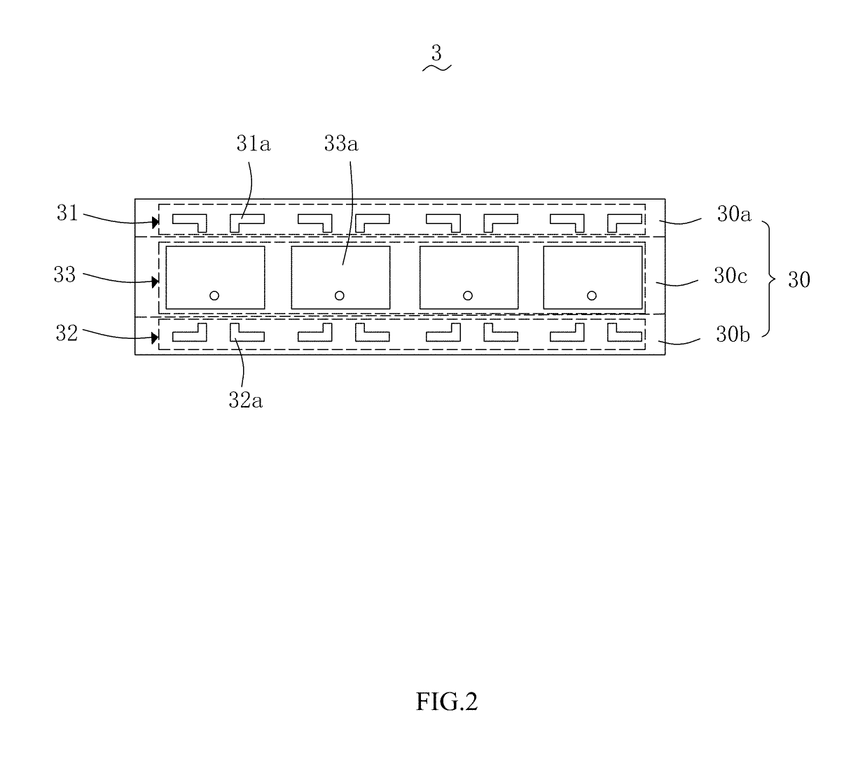

Referring to FIGS. 1 and 2 together, the antenna component 3 includes a flexible circuit board 30 received in the 3D glass housing 1 and integrated with and fixed to the PCB 2. The flexible circuit board 30 has one end integrated with and fixed to the PCB 2 and another end bent and extending to be closely attached to an inner surface of the 3D glass housing 1.

The flexible circuit board 30 includes a first portion 30a, a second portion 30b arranged oppositely to the first portion 30a and a third portion 30c connected to the first portion 30a and the second portion 30b.

The antenna component includes a first antenna array 31 arranged on the first portion 30a, a second antenna array 32 arranged on the second portion 30b and a third antenna array 33 arranged on the third portion 30c. The first antenna array 31, the second antenna array 32 and the third antenna array 33 can be bent with the first portion 30a, the second portion 30b and the third portion 30c, respectively, such that the first antenna array 31, the second antenna array 32 and the third antenna array 33 can be closely attached to an inner surface of the 3D glass housing 1 via the first portion 30a, the second portion 30b and the third portion 30c, respectively. In particular, the first antenna array 31, the second antenna array 32 and the third antenna array 33 can be printed on the first portion 30a, the second portion 30b and the third portion 30c, respectively, such that the thickness of the antenna component 3 can be greatly reduced and the antenna component 3 can be easily bent with flexible circuit board 30 while guaranteeing the structural stability of the first antenna array 31, the second antenna array 32 and the third antenna array 33.

The first antenna array 31 includes a plurality of first radiating antennas 31a, the second antenna array 32 includes a plurality of second radiating antennas 32a and the third antenna array 33 includes a plurality of third radiating antennas 33a. In this embodiment, each of the antenna arrays includes four radiating antennas which are arranged as a one-dimensional straight-line array. In particular, referring to FIG. 2, the first radiating antennas 31a and the second radiating antennas 32a are monopole antennas and the third radiating antennas 33a are patch antennas.

In this embodiment, the 3D glass housing 1 can be a curved glass screen, including a screen 11, a back cover 12 spaced apart from the screen 11 and a side wall 13 connecting the screen 11 and the back cover 12. Since the 3D glass housing 1 is made of glass, the impact on the electromagnetic wave radiated by the antenna component 3 can be reduced as much as possible, thereby reducing the spatial loss of the electromagnetic wave.

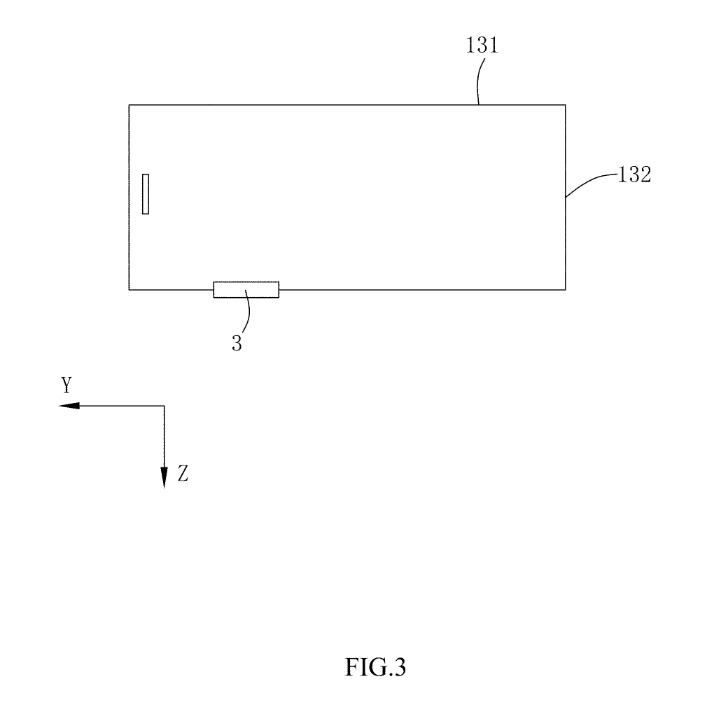

As shown in FIG. 3, the side wall 13 includes two opposite long-edge side walls 131 and two opposite short-edge side walls 132 connecting the two long-edge side walls 131. The antenna component 3 is arranged correspondingly to the long-edge side walls 131. The long-edge side walls 131 include a handheld portion to be held by a user's palm and a non-handheld portion not to be held by a user's palm. The antenna component is arranged correspondingly to the non-handheld portion, so as to reduce the impact of metal elements within the mobile terminal 100 on the radiation performance of the antenna component 3.

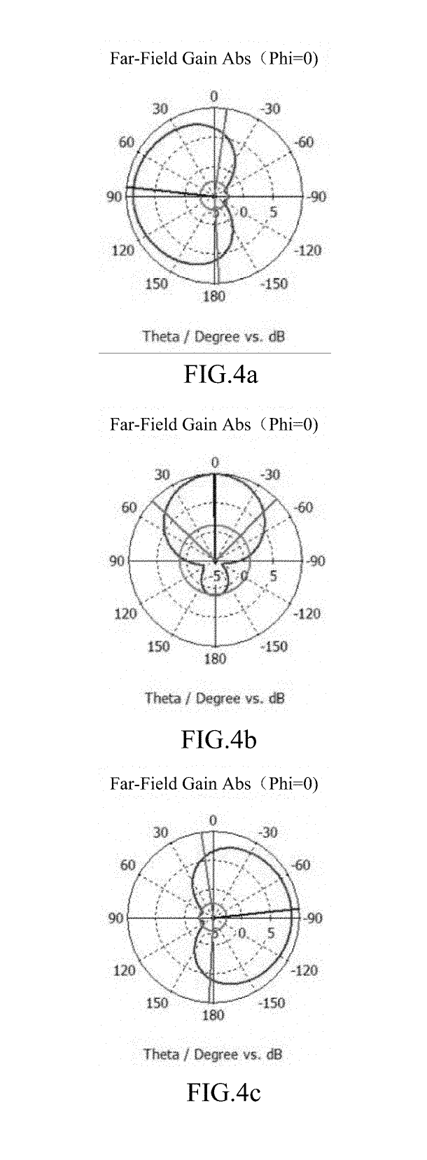

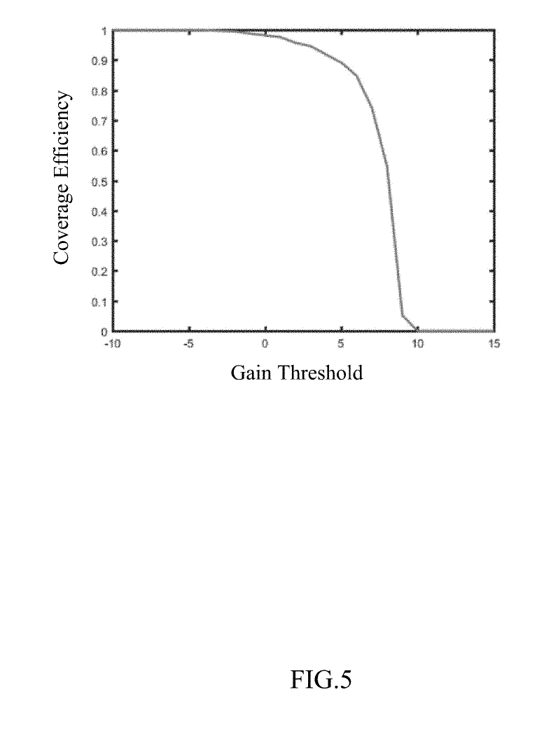

In particular, the first portion 30a is closely attached to an inner surface of the screen 11, the second portion 30b is closely attached to an inner surface of the back cover 12 and the third portion 30c is closely attached to an inner surface of the side wall 13. In this way, the first antenna array 31 is arranged oppositely to the screen 11 so as to radiate electromagnetic waves towards the screen, the second antenna array 32 is arranged oppositely to the back cover 12 so as to radiate electromagnetic waves towards the back cover, and the third antenna array 33 is arranged oppositely to the side wall 13 so as to radiate electromagnetic waves towards the side wall. As shown in FIG. 4(b), the beam from the third antenna array 33 points to a direction of Theta=0°, i.e., the positive direction along the Z-axis. As shown in FIGS. 4(a) and 4(c), the first antenna array 31 and the second antenna array 32 point to direction of Theta=90° and Theta=−90°, i.e., the positive and negative directions along the X-axis, respectively. Referring to FIG. 5, it can be seen that the antenna component 3 according to the present disclosure has an extremely high coverage efficiency. The unit for the abscissa of FIG. 5 is dB.

The first antenna array 31, the second antenna array 32 and the third antenna array 33 are all linear arrays, which occupy a small area on the flexible circuit board 30 such that the second antenna array 32 can be closely attached to the side wall 13 of the 3D glass housing 1.

The antenna component 3 further includes an antenna control circuit (not shown) provided on the PCB 2. The antenna control circuit is connected to the first antenna array 31, the second antenna array 32 and the third antenna array 33, so as to be integrated with a mainboard in the mobile terminal 100.

Compared with the related art, the antenna component 3 of the present disclosure has the following advantageous effects:

1) The antenna control circuit is provided on the PCB 2, so as to be integrated with the mainboard.

2) The first antenna array 31, the second antenna array 32 and the third antenna array 33 are attached to the flexible circuit board 30 and easy to be bent, such that the antenna can be closely attached to the 3D glass housing.

3) The first antenna array 31, the second antenna array 32 and the third antenna array 33 are arranged on the inner surface of the 3D glass housing 1, so as to reduce the impact of the metal elements within the mobile terminal 100 on the radiation performance of the antenna component, thereby reducing the spatial loss of the electromagnetic wave.

4) The first antenna array 31, the second antenna array 32 and the third antenna array 33 are arranged on the flexible circuit board 30 and the antenna control circuit is arranged on the PCB 2, so as to greatly reduce the overall size of the radiating antennas while fully utilizing the inner space of the mobile terminal 100.

5) With the flexible circuit board 30, the first antenna array 31, the second antenna array 32 and the third antenna array 33 can be closely attached to the 3D glass housing 1. In this way, it is possible to avoid distortions in the direction diagrams due to air existing between the 3D glass housing 1 and the first antenna array 31, the second antenna array 32 and the third antenna array 33, without affecting the radiation performance of the radiating antennas.

6) With the flexible circuit board 30, the first antenna array 31, the second antenna array 32 and the third antenna array 33 can be closely attached to the inner surface of the 3D glass housing 1, such that the antenna component can have a higher mechanical stability and the radiating antennas will not be damaged, fail or have degraded radiation performance due to fall-off or vibration.

7) The antenna arrays are all linear arrays which occupy a small area on the flexible circuit board and can be fully attached to the side wall 13 of the 3D glass housing 1.

8) By designing the positions of the first antenna array 31, the second antenna array 32 and the third antenna array 33, beams can be radiated in different directions, leading to a large overall scanning space and a small dimension.

While the embodiments of the present disclosure have been described above, various modifications can be made by those skilled in the art without departing from the principle of the present disclosure. These modifications are to be encompassed by the scope of the present disclosure.

What is claimed is:

1. An antenna component, applied in a mobile terminal comprising a three-dimensional (3D) glass housing and a Printed Circuit Board (PCB) received in the 3D glass housing, the 3D glass housing comprising a screen, a back cover spaced apart from the screen and a side wall connecting the screen and the back cover, wherein the antenna component comprises:
a flexible circuit board having one end integrated with and fixed to the PCB and another end bent and extending to be closely attached to an inner surface of the 3D glass housing, the flexible circuit board comprising a first portion closely attached to an inner surface of the screen, a second portion arranged oppositely to the first portion and closely attached to an inner surface of the back cover and a third portion connected to the first portion and the second portion and closely attached to an inner surface of the side wall;
a first antenna array arranged on the first portion;
a second antenna array arranged on the second portion; and
a third antenna array arranged on the third portion.

2. The antenna component as described in claim 1, wherein the first antenna array, the second antenna array and the third antenna array are printed on the first portion, the second portion and the third portion, respectively.

3. The antenna component as described in claim 2, wherein the side wall comprises two opposite long-edge side walls and two opposite short-edge side walls connecting the two long-edge side walls, and wherein the antenna component is arranged correspondingly to the two long-edge side walls.

4. The antenna component as described in claim 3, wherein each of the first antenna array, the second antenna array and the third antenna array is a one-dimensional straight-line array.

5. The antenna component as described in claim 4, wherein the first antenna array comprises a plurality of first radiating antennas, the second antenna array comprises a plurality of second radiating antennas, and the third antenna array comprises a plurality of third radiating antennas, and wherein the first radiating antennas and the second radiating antennas are dipole antennas and the third radiating antennas are patch antennas.

6. The antenna component as described in claim 5, wherein the long-edge side walls each comprise a handheld portion and a non-handheld portion, and wherein the antenna component is arranged correspondingly to the non-handheld portion.

7. A mobile terminal, comprising the antenna component according to claim 1.
